(19) United States
(12) Patent Application Publication
(10) Pub. No.: US 2015/0079252 A1
(43) Pub. Date: Mar. 19, 2015

(54) BANANA STORAGE AND SHIPPING BAGS

(71) Applicants: Jiwon Jeong, Hollywood, FL (US); Francisco Javier Rodriguez Murillo, Alajuela (CR)

(72) Inventors: Jiwon Jeong, Hollywood, FL (US); Francisco Javier Rodriguez Murillo, Alajuela (CR)

(73) Assignee: Chiquita Brands LLC, Charlotte, NC (US)

(21) Appl. No.: 14/456,267

(22) Filed: Aug. 11, 2014

Related U.S. Application Data
(60) Provisional application No. 61/865,816, filed on Aug. 14, 2013.

(51) Int. Cl. B65D 81/34; B65B 25/04; A23B 7/152

(52) U.S. Cl. CPC B65D 81/34; A23B 7/152; B65B 25/041; A23V 2002/00
USPC 426/316; 53/473; 53/469; 383/105; 428/220; 428/131

(57) ABSTRACT

A film for wrapping respiring produce is disclosed. The film comprises from about 60% to about 90% of an ethylene vinyl acetate (EVA) mixture which consists of (for example, from about 75% to about 90%) ethylene vinyl acetate and (for example, from about 10% to about 25%) vinyl acetate, with the balance of the film selected from food-safe, EVA-compatible, thermoplastic resins, such as low density polyethylene, linear low density polyethylene, and mixtures of those materials. A bag for storage and shipment of respiring produce, such as bananas, made from that film material, as well as a method for shipping and storing respiring produce, such as bananas, avocados, salad components or flowers, utilizing that bag, are also disclosed.

This application is related to and claims priority from U.S. Provisional Patent Application No. 61/865,816, filed Aug. 14, 2013, incorporated herein by reference.

### TECHNICAL FIELD

The present invention relates to the field of packaging respiring fruits, vegetables, salad components and flowers for storage and shipment and, in particular, to films and bags used for such purpose.

### BACKGROUND

The shipment of respiring produce (e.g., avocados, bananas, mangoes, plantains, papayas, tomatoes, berries, stone fruit, mushrooms, beansprouts, broccoli) from the farm to the retail outlet and ultimately to the consumer is a very tricky process which needs to be managed carefully in order to assure arrival at retail of high quality fruit and vegetables which remain fresh, ripe and can be marketed for a reasonable period of time. This is particularly true with bananas and other fruit which are grown in tropical climates and frequently need to be shipped long distances to more temperate climates in such a fashion that they arrive on the retail shelves at the appropriate point in their ripening cycle where they are attractive to the consumer and still have a reasonable edible shelf life remaining after they are purchased. The net result is that great care must be taken to provide and ensure specifically-defined storage conditions during their shipment and storage.

The storage conditions can be characterized by defined temperature, moisture, and gas medium composition surrounding the bananas (while this discussion will focus on bananas, it is equally applicable to other respiring produce, particularly fruit and avocados). If the storage conditions are not adhered to, the bananas will not be delivered to the consumer in the required condition, for example, in terms of ripeness of the product, and will spoil quickly. Companies go to significant lengths and expense to assure that such shipping, storage and ripening conditions are present. For example, during conventional transport and storage, the bananas are generally packaged into boxes as clusters in their green, non-ripe condition. These boxes are assembled in stacks on pallets and are placed into big transportation containers. During the process of loading and transport, a temperature between 56° and 58° F. is generally maintained. At such temperature, the bananas can be stored for a long time in an unripe state.

To start the ripening process, room temperature of the bananas can be adjusted in a range of from about 58° F. to about 62° F. (according to the fruit and market conditions), and the gas composition surrounding the bananas can be modified by adding ethylene to it. The combination of ethylene and increased temperature helps to start the ripening process. Further on, when the bananas are delivered to the distribution network, care must be taken so that they do not ripen too quickly, do not spoil, remain in good market and consumer condition, and they should be packed in a manner which allows the consumer to view them prior to purchase.

Modified packaging is being used to improve and extend the shelf life of bananas (and avocados) beyond what is achievable with typical shipping processes. In one such modified process, this is handled by adding ethylene to bags which contain the bananas (or avocados) and then subsequently sealing the bags, at an intermediate point during the course of the shipment. This additional sealing step during shipment adds time and expense to the process. The requirements of modified atmosphere packaging requires the creation of special packages which provide both the change in gas medium surrounding the packaged product and the preservation of their market condition.

The goal, then, is to ship bananas (or any other respiring fruit or vegetables) in a manner which maintains positive eating characteristics while maximizing the marketing shelf time during which they remain at the preferred edible stage. In other words, the desired effect is to maximize banana shelf life without compromising their eating characteristics. Packages have been developed in the past for the purpose of regulating the shipping, storage and ripening conditions of bananas. Examples of such packages are described below, but they tend to be relatively complex and expensive to utilize. The present invention addresses this concern by achieving the defined goal utilizing a very effective, simple and less expensive approach than that generally utilized in the art.

EPO Published Patent Application EP 752378, Controlled Atmosphere Packaging For Fruit And Packaging Method, published Jun. 13, 2001, defines a method for packaging fruit, particularly bananas, that includes a hermetically-sealed bag with at least one unripe fruit placed inside it; the bag being made of a polymer material film, the thickness of which is 20-50 microns, and which is filled with a modified atmosphere. The polymer material can be low density polyethylene, polyethylene, high density polyethylene, polypropylene, polyethylene teraphthalate, and other materials. The modified atmosphere includes from 2-20% oxygen (vol.), from 6-13% carbon dioxide (vol.), and from 0.1-1.5% ethylene (vol.), with the remainder being nitrogen.

U.S. Pat. No. 6,013,293, Packing Respiring Biological Materials With Atmosphere Control Member, De Moor, granted Jan. 11, 2000, describes a package that is said to ensure the necessary gas composition in the storage of fruits and vegetables, as well as other respiring biological materials. A selective gas-permeable membrane, which is part of this package, conducts oxygen at a lower rate than other gases, in particular, carbon dioxide and ethylene. Using such a membrane in packaging for banana storage is said to ensure optimal conditions for banana ripening, but adds quite a bit of expense to the shipping and ripening process. Note that shipping expense is particularly difficult to absorb when dealing with an inexpensive commodity item like fruit.

U.S. Pat. No. 6,548,132, Packaging Biological Materials, Clarke et al, issued Apr. 15, 2003, defines a package that includes a sealed container, respiring biological material, and a gas medium inside the container. The container has walls that are relatively impermeable to oxygen and carbon dioxide, and is equipped with an atmosphere-control element inside the container. The control element includes a gas-permeable membrane consisting of a micro-porous film in the form of a polymer matrix, having a network of gas-impermeable pores and a polymer coating applied over the film. The package is said to ensure the generation of a gas medium inside the container which is favorable for strong respiring biological materials; however, it is relatively expensive to implement.

U.S. Published Patent Applications 2008/0008793 and 2008/0008794, Forsyth et al, published Jan. 10, 2008, defines a method for extending the ripening period and retail shelf life of respiring produce, particularly bananas. The applications define the optimal atmosphere for packaging bananas as containing between 1 and 6 weight percent of oxygen and between 3 and 10 weight percent of carbon dioxide in the gas medium, and further having a specific ratio of oxygen to carbon dioxide within a narrowly-defined range.

U.S. Pat. No. 6,190,710, Nir et al, granted Feb. 20, 2001, defines a method for preserving produce by providing a plastic packaging material having a thickness of up to 500 microns and a permeability to water vapor exceeding about 1.5 g mm/m² per day at 38° C. and 85-90% relative humidity, whereby when the material is used to package produce, no condensation or minimal condensation appears on the surface of the material. The patent defines packages utilizing this material; the packages contain an atmosphere which includes 4-20% oxygen and 0.5-17% carbon dioxide.

U.S. Published Patent Application 2005/0266129, Mir, published Dec. 1, 2005, defines packages and preservation processes for initiating and controlling the ripening rates of perishable food products, such as bananas. The package is a polymeric perforated package which is said to control the atmosphere within the package as the fruit progresses through its ripening stages so as not to appreciably delay ripening to an intermediate ripening stage, but to delay ripening, and thus increase shelf life, of the food product beyond such intermediate ripening stage. The atmosphere within the package is said to contain less than 10% oxygen, 5-20% carbon dioxide, and have a relative humidity of greater than 70% during at least a portion of the ripening, distribution or storage process.

U.S. Published Patent Application 2011/0293802, Alfaro et al, published Dec. 1, 2011, defines a film and bags for wrapping respiring produce. The film includes 2-22% ethylene vinyl acetate with the balance of the film containing a food-safe, compatible, thermoplastic resin, such as linear low density polyethylene.

The present invention, then, provides an improved shipping film and bag for perishable respiring produce products, such as bananas and avocados, which provides a mechanism to control gas-permeability in such a way that freshness is maintained in the supply chain; yellow fruit life is extended to reduce shrinkage at the point of sale; and the package can be sealed for some produce at the point of fruit origin without negatively affecting the ripening process and ripening uniformity. This bag may be micro-perforated, and, in one embodiment, is made of a blend of an ethyl vinyl acetate mixture, and a polyethylene resin to form a final film which contains about 60% to about 90% of the ethyl vinyl acetate mixture. The bag increases yellow fruit or ready-to-eat shelf life by maintaining optimal required gas levels during the ethylene-gassing procedure, as well as transportation and backroom conditions at the point-of-sale. This type of bag can be applied to any perishable respiring produce product in order to increase its green and yellow shelf life. The bags decrease dehydration of the fruit, thereby improving fruit freshness and reducing weight loss in the packages. The bags can also be used with salad components and flowers. The bags can be hermetically-closed at the point of origin, allowing the transference of ethylene gas during the ripening procedure (i.e., the bags do not need to be opened during the ripening procedure for some applications), which can be an advantage in the overall process. The bags can also be shipped open and then sealed, either during shipping or at market. This invention will be described in more detail below.

### SUMMARY

The present invention relates to a film for wrapping respiring produce, comprising from about 60% to about 90% of an ethylene vinyl acetate (EVA) mixture, and the balance of the film (about 10% to about 40%) selected from any polymeric thermoplastic resin material, compatible with ethylene vinyl acetate, that can be used to form food-safe film bags, such as low density polyethylene, linear low density polyethylene, and mixtures thereof. The precise percentage of ethylene vinyl acetate to be used will depend on factors such as packing size and weight, film thickness, type of produce, storage time, storage conditions, transportation requirements, and required yellow life.

The present invention also relates to a bag, for the shipment of respiring produce, made from the film described above. As used herein, “bag” refers to a container, usually with a tubular construction, made from a flexible thermoplastic resin, generally by a blown film tube extrusion process. Specifically, the bag comprises a rectangular top sheet and a rectangular bottom sheet joined together along at least three of their edges, at least a portion of said top and bottom sheets made from a film comprising from about 60% to about 90% of an ethylene vinyl acetate mixture, and the balance (from about 10% to about 40%) selected from an EVA-compatible food-safe thermoplastic resin, such as low density polyethylene, linear low density polyethylene, and mixtures thereof.

The present invention also relates to a method for shipping respiring produce, such as bananas, comprising the steps of wrapping said produce in the film, defined above, or placing said produce in one or more bags, as defined above, and shipping said produce from a point-of-origin to a destination point. In one embodiment, the fourth edge of the bag is sealed after the produce (e.g., bananas) is placed in it but before it is shipped. In another embodiment, the bags holding the produce are shipped in an open container, but are sealed at market.

All percentages and ratios given herein are “by weight” unless otherwise specified. All references cited in this specification are incorporated herein by reference, in their entirety, unless otherwise specified.

### BRIEF DESCRIPTION OF THE DRAWINGS

FIG. 1 is a plan view of a representative shipping bag of the present invention.

FIG. 2 is a plan view of a second embodiment of the present invention.

FIG. 3 is a plan view of a third embodiment of the present invention.

FIG. 4 is a plan view of a fourth embodiment of the present invention.

FIG. 5 is a plan view of a fifth embodiment of the present invention.

FIG. 6 is an embodiment of the present invention particularly adapted for transport of avocados.

### DETAILED DESCRIPTION

The present invention defines a bag for the shipping and storage of respiring produce, such as bananas, as well as a method for shipping such produce utilizing the bag. The invention also encompasses a specifically-defined polymeric film which is used in making the bag or otherwise in packing the produce (for example, wrapping the produce in the film or placing the produce on a tray or in a package which is then covered with the film). The bags and the film are simple to use. The bag and the process allow bananas to be shipped from their point of production in the tropics in sealed bags. This greatly simplifies the handling of the bananas in that it does not require that the bags be initially shipped open and then sealed at a later point during the shipment (although that shipping protocol (e.g., bags shipped open and sealed at market) is also possible using the present invention), while still allowing the bananas to ripen under modified atmosphere in route or later. The bag is permeable to ethylene which permits the ripening to take place at the appropriate pace. Further, the bag and the defined process keep bananas yellow longer (i.e., they have a longer shelf life) and provide reduced moisture loss, reduced peel splitting, and reduced weight loss for the fruit. The net result is that the fruit have very good visual and eating characteristics for the consumer.

The films of the present invention which may be used for wrapping respiring produce, such as bananas, comprise from about 60% to about 90% of an ethylene vinyl acetate (EVA) mixture, with the balance of the film comprising a food-safe EVA-compatible thermoplastic resin material, such as low density polyethylene, linear low density polyethylene or mixtures of those materials. The content of the ethylene vinyl acetate material is important for achieving the right level of gas-permeability in the film. The EVA mixture is made up by from about 75% to about 90% ethylene vinyl acetate (EVA) and from about 10% to about 25% vinyl acetate (VA). Thus, the film (which includes from about 60% to about 90% of the mixture) contains from about 45% to about 81% of ethylene vinyl acetate itself (and from about 6.0% to about 22.5% of the vinyl acetate itself). The use of such high levels of EVA in the film would not have been obvious since such high EVA levels would be thought to compromise the strength of the film, particularly when used to package larger amounts of fruit.

The film typically contains from about 60% to about 90% (by weight), for example from about 70% to 85%, for example from about 75% to about 85% and for example about 80%, of the ethylene vinyl acetate mixture (which includes a mixture of EVA and VA, as described above).

The balance of the film, for the most part, comprises a food-safe compatible thermoplastic resin material, such as a polyethylene (PE) material, specifically a low density polyethylene material, or more preferably a linear low density polyethylene material. Each of those materials provides manufacturing and use characteristics to the bag, known in the art. Mixtures of those materials can also be used. The polyethylene material is included in the film primarily for processing purposes, enabling and improving the extrusion characteristics of the film. The film typically contains from about 10% to about 40%, for example, from about 15% to about 30%, for example, from about 15% to about 25%, and for example, about 20% of the polyethylene material. Calcium carbonate (CaCO₃), calcium hydroxide (Ca(OH)₂), or any other CO₂-absorbing substance may be used as a replacement for a portion of the EVA/PE resin blend, to enhance the efficacy of the bag. Ultra low density polyethylene could also be used in the polymer mixture. Moisture absorbing materials can also be included in the film.

In the film, the EVA mixture and the polyethylene material are mixed together in a single film. It is not in the form of a laminate where the EVA and polyethylene materials are present in separate layers.

The thickness of the film is also important. If the film is too thin, it is difficult to extrude; however, if the film is too thick, the gas-permeability of the film is adversely affected and the atmosphere within the package can become problematic in terms of transport and ripening of the fruit. The film is typically from about 0.5 mils to about 5 mils thick; one embodiment of the film has a thickness of from about 0.5 mils to about 2 mils thick, with a specific embodiment of the film being 0.5 mils thick. The film is formed in a conventional fashion, such as by extrusion. The bags are formed from the film using processes well-known in the art, such as blown film extrusion (also called the tubular film process). The film does not have to be used as bags; it may be used to wrap the produce during shipping and/or storage, or the produce may be placed in a package or tray which is then covered with the film.

Although the film, as described herein, is permeable to oxygen, carbon dioxide and ethylene, micro-perforations may optionally be included in the film in order to adjust and optimize the atmosphere contained in a package made from the film. For example, micro-perforations in the film can be used to adjust the oxygen or the carbon dioxide level or the moisture level in such a package. In addition to the ethylene vinyl acetate and polyethylene components, the films may include processing additives, such as slip, and anti-block additives, at their conventional art-established levels. For example, the film can include additives to enhance biodegradability, carbon dioxide, moisture and ethylene-absorbing materials, and pigments, according to the final packing requirements. Anti-block additives prevent the plastic layers from sticking together. Slip additives help the plastic bag to open more easily and allow items to slide in smoothly.

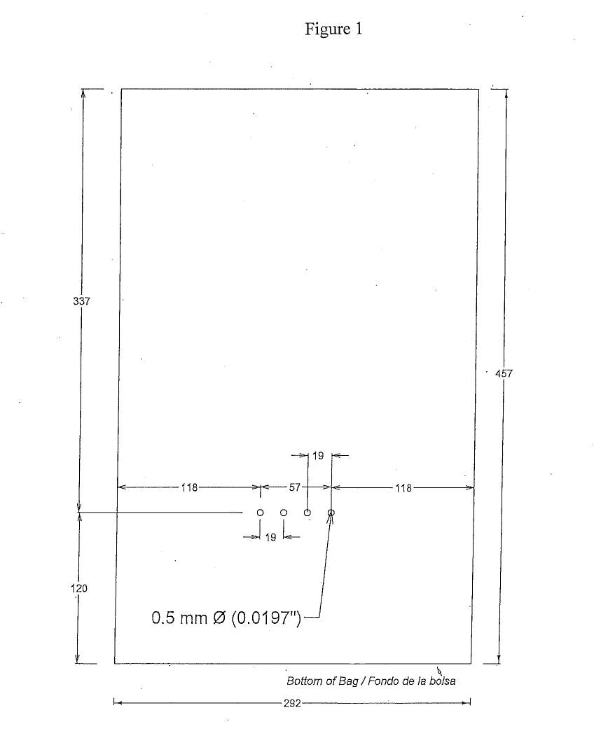

The film, as described above, can be used to form the shipping bags of the present invention. Examples of such shipping bags are described in FIGS. 1-6 of the present application. The bags typically comprise a rectangular top sheet and a rectangular bottom sheet joined together along at least a portion of three of their edges (preferably they are joined together along the entirety of three edges), at least a portion of the top sheet and the bottom sheet being formed from the film described above.

As used, herein, the term “rectangular” is not restricted to its specific geometrical definition (i.e., four sides at right angles, two pairs each of different lengths), but rather is intended to include squares as well as any other quadrilateral (four-sided) shapes, as long as the shapes of the top sheet and the bottom sheet are reasonably congruent to each other. The sides of the bags can be curved or straight. In forming the bags of the present invention, at least a portion of the top sheet or the bottom sheet is made up of the defined film. In one embodiment, at least a portion of both the top sheet and the bottom sheet are made up of the film, and in another embodiment, the complete top and bottom sheets are made up from the film.

The bags as defined herein are used to hold, ship and/or store respiring produce, preferably bananas. Typically, the bags are of such size as to hold from about 0.10 to about 60 pounds of fruit. In one embodiment, the bags hold from about 0.25 to about 50 pounds of fruit. For example, the bags may be formulated to hold 3 lbs, 4 lbs, 10 lbs, 30 lbs or 40 lbs of fruit. The bags may even be sized to hold a single piece of fruit. To do that, each edge of the bag is generally between about 3″ and about 52″ in length. Bag size will depend on the kind and amount of produce to be packed. The length of the bag will typically be between about 8″ and 52″, and the width between about 3″ and 40″. At least three of the edges of the bag sides are typically fastened together to form the bag. The sheets may be fastened by any known and conventional process, such as heat-sealing. In one embodiment, the top and bottom sheets are fastened on three sides to form the bag. Each side is fastened over its entire length. The bananas may then be placed through the open end and into the bag. The open end may then be sealed in any known manner, such as with a zip lock closure or by making a knot in the bag or using a wire or plastic closure, a rubber band or adhesive strip, or using a heat sealer, for example at the packing station. The bags are then placed into a shipping box for transport from the point-of-origin to their desired destination. It is to be understood that the bags may be, but do not have to be, sealed prior to shipping; the produce may be shipped in open bags which are sealed upon arrival at an intermediate point or their final destination. In addition to the produce, the bags may hold a material which absorbs oxygen, carbon dioxide or moisture, such as a moisture-absorbing pad, in order to control the atmosphere in the bags.

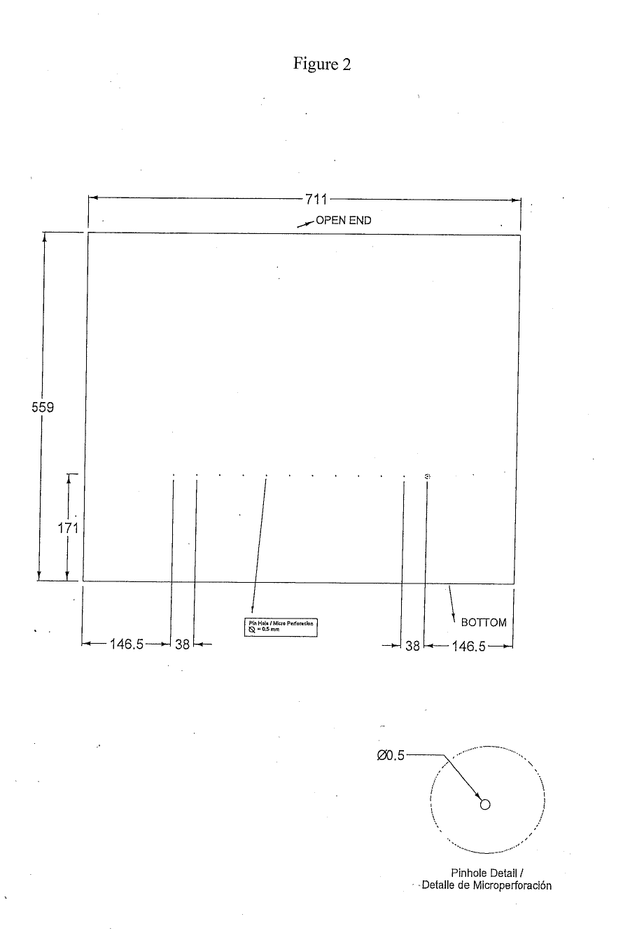

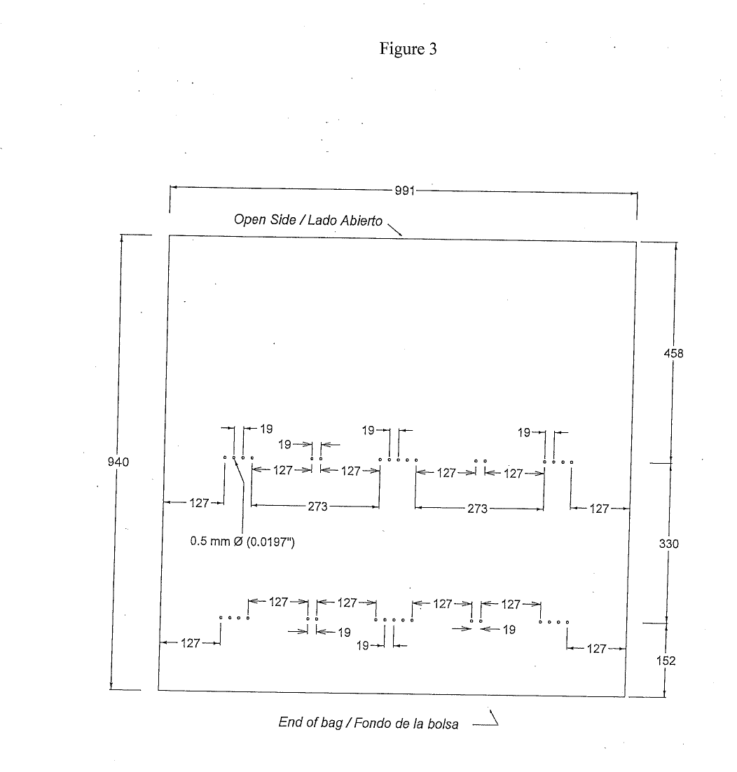

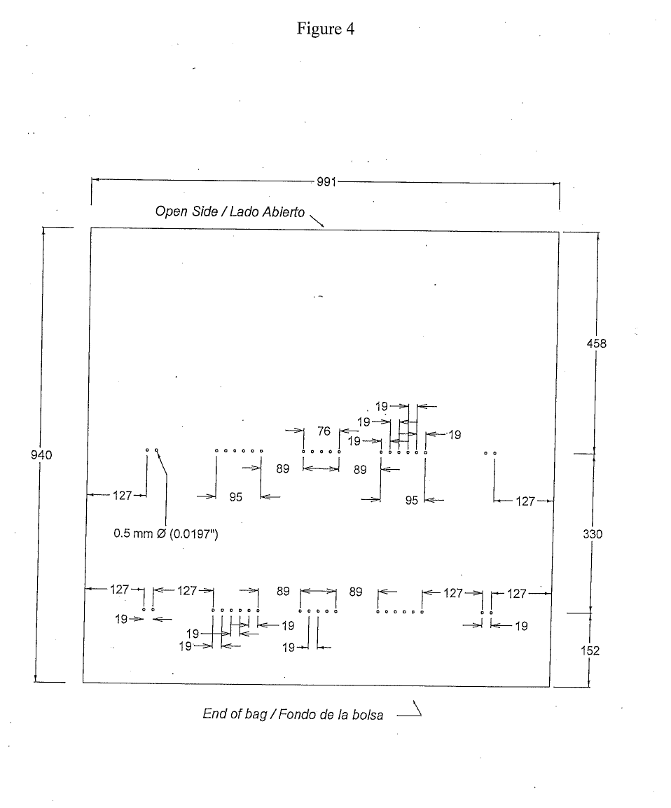

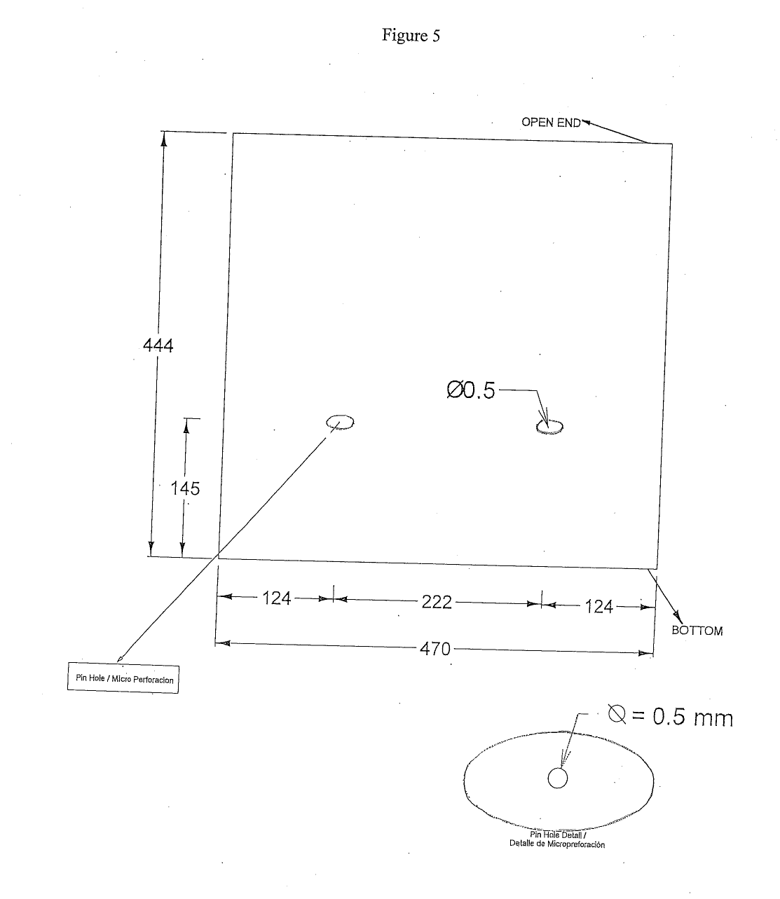

The polymer material, as defined above, and the structure of the bag are selected in order to provide an appropriate atmosphere (specifically in terms of moisture, oxygen, carbon dioxide and ethylene) in the bag for the bananas. Thus, for example, micro-perforations may be utilized in the film material in order to adjust the moisture or oxygen levels in the package. In some embodiments, the film can be used without any micro-perforations. When used, such micro-perforations may be made in one or both of the top and bottom sheets which comprise the bag. Preferably, there are between about 1 and about 100 pinholes per sheet, including between about 1 and about 50 pinholes (the pinholes having a diameter of from about 0.10 mm to about 12.5 mm, including diameters of from about 0.25 mm to about 2.0 mm, such as about 0.5 mm). In one embodiment (see FIG. 1), typically used for about 3 lbs. of fruit, each of the top and bottom sheets includes 4 pinholes (each sheet comprising approximately 1.5 square feet of film having a film thickness of 1.0 mils). FIG. 2, typically used for about 10 lbs. of fruit, shows an embodiment which includes 12 pinholes in each of the top and bottom sheets (each sheet comprising about 4.25 square feet of film having a film thickness of 0.7 mils). FIG. 3, typically used to hold about 30 lbs. of fruit, shows an embodiment which includes 34 pinholes in each of the top and bottom sheets (each sheet comprising about 10 square feet of film having a film thickness of 0.7 mils). FIG. 4, typically used to hold about 40 lbs. of fruit, shows an embodiment which includes 42 pinholes in each of the top and bottom sheets (each sheet comprising about 10 square feet of film having a film thickness of 0.7 mils). FIG. 5, typically used to hold about 4 lbs (1.8 kg) of fruit (about 9 single fingers of regular size or 15 single fingers of small size bananas), shows an embodiment which includes 2 pinholes in each of the top and bottom sheets (each sheet comprising about 2.25 square feet of film—the film being about 0.7 mil thick). The resin material, the size of the bag and micro-perforations (both in terms of number, size, and placement) are selected to provide an atmosphere in the bag which optimizes eating characteristics, visual characteristics, and yellow shelf-life of the bananas. The number and placement of perforations is also related to the diameter of the perforations, such that the desired atmosphere is achieved inside the bag. Examples of bags of the present invention include:
a 3 lb capacity bag having 8 micro-perforated holes (0.5 mm diameter)
a 4 lb capacity bag having 4 micro-perforated holes (0.5 mm diameter)
a 10 lb capacity bag having 24 micro-perforated holes (0.5 mm diameter)
a 30 lb capacity bag having 68 micro-perforated holes (0.5 mm diameter)
a 40 lb capacity bag having 84 micro-perforated holes (0.5 mm diameter)

The bag material should provide permeability to oxygen, carbon dioxide and ethylene and, in one embodiment, the goal is to keeps the atmosphere in the sealed bag containing bananas in the range of from about 2% to about 12% oxygen and from about 3% to about 13% carbon dioxide during at least a significant portion of the time between the ripening of the bananas and the opening of the bag.

Finally, the present invention encompasses a method for shipping respiring produce comprising the steps of placing said produce in one or more bags as described above, and shipping said produce from an origination point to a destination point.

As used herein, “origination point” (also known as “point-of-origin”) can be used to denote the origination point for an entire trip or the origination point for one of several individual legs of the trip. Similarly, “destination point” can be used to denote the final destination or an intermediate destination along the shipping route. The shipping route can include multiple shipping legs by multiple means of transportation and can also include periods of storage which can be under controlled temperature and/or humidity conditions. Thus, for example, bananas can be packaged at a banana plantation in Costa Rica and then shipped by truck to an ocean port, at which point they are loaded onto a ship which then takes them to a shipping port in, for example, the United States (e.g., Gulfport, Miss.), at which point they may be stored or loaded onto trucks which take them to various retail distribution centers throughout the United States (for example, in Cincinnati, Ohio) and ultimately to individual grocery stores where they are sold to consumers. In such a scenario, it can be taken that the origination point for the entire journey is the banana plantation and the final destination point is the retail store or the consumer's home. However, each individual leg can also be considered, for example, such that the origination point for an individual leg is at Gulfport (i.e., the U.S. shipping/receiving port) and the destination point for that leg is Cincinnati (i.e., the distribution center for a grocery chain).

In one example of the shipping method of the present invention, the produce shipped are bananas and each bag contains from about 0.10 to about 60 pounds of the bananas. The bananas are placed in such bags. In one case, boxes are packed with fruit in open bags are palletized and the pallets are loaded into containers. At this point, the fruit may be treated with ethylene gas to begin the process of ripening in a controlled manner, although that is not always required. If treated with ethylene, this is accomplished by adding ethylene to the open bags, and then sealing the bags at the distribution center. In many cases, the bags will be sealed without prior ethylene treatment. The ability to seal the bag at the point of shipment is one aspect of the present invention. The sealing of the bag at the point-of-shipment simplifies the shipping process, making it unnecessary to open up the boxes at a later time to seal the bags at that point; it also minimizes moisture loss from the bananas. It is to be emphasized, however, that the bags do not have to be sealed at the point of shipment; they can be sealed at an interim shipping point, at their destination, or not sealed at all.

Because the film is ethylene-permeable, the bananas may be exposed to ethylene to start the ripening process even after bag sealing by exposing the bags to an ethylene atmosphere. For example, the bags may be sealed at the point of packing and shipment and shipped green to the distribution center where the fruit is gassed with ethylene (through the sealed bag) to begin the ripening process. Alternatively, ripening with ethylene can also commence within the container on the vessel or on land upon arrival in the market. The bags are permeable to oxygen, carbon dioxide and ethylene, such that the atmosphere in the sealed bags during at least a portion of the shipment of bananas contains from about 2% to about 12% oxygen and from about 3% to about 13% carbon dioxide. It should also be noted that, depending on particular needs, the bags can also be shipped open and, if required, sealed after ethylene gassing at the distribution center.

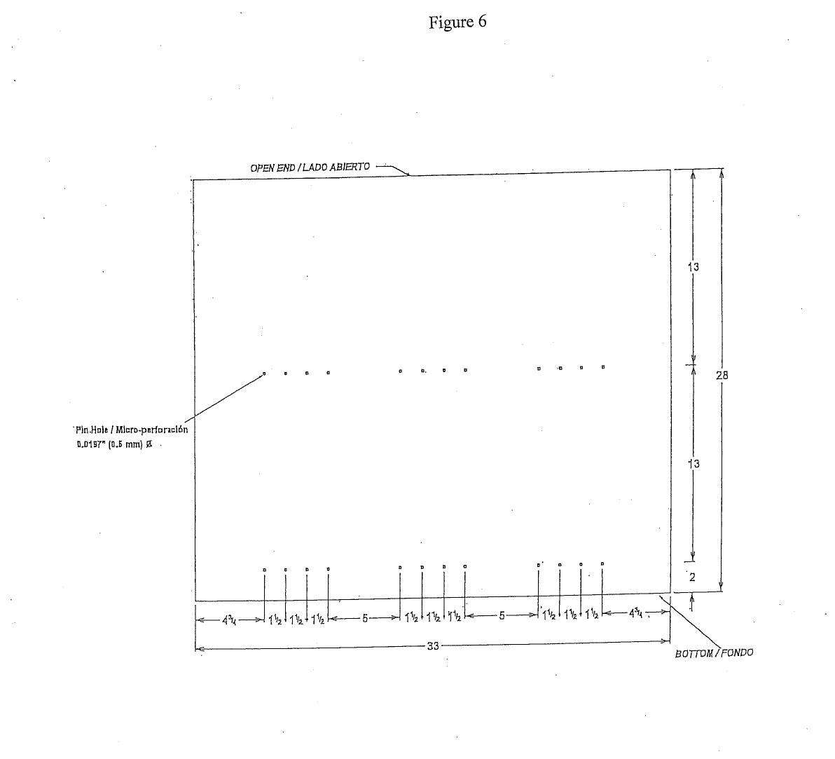

The film, bags and process described in the present application can be adapted for use with other types of produce. For example, for the transporting of avocados, they are stored at 35-40° F. and the bag is formulated such that the included atmosphere contains from about 6% to about 13% oxygen and from about 2% to about 7% carbon dioxide during at least a portion of the time between the ripening of the avocados and the opening of the bag. FIG. 6 defines a bag of the present invention particularly useful for the packaging and transport of avocados. In addition, the film, bags and process can also be used, for example, to store and transport salad components and flowers.

### EXAMPLE

A bag of the present invention is made as follows.

Extrusion Process—

The raw plastic material is fed in pellet form into an extruder. The plastic is conveyed forward by a rotating screw inside a heated barrel and softened by both friction and heat. The softened plastic is then forced upwards through a circular die in the shape of a hollow tube, called a “bubble”. This process is known as “blown film extrusion”. The film comprises 80% (by weight) of an ethyl vinyl acetate mixture (the mixture consisting of 85.5% EVA and 14.5% VA), with the balance being linear low density polyethylene, and has a thickness of about 0.7 mils. This is a continuous process where the tube is expanded with air above the die, and collapsed by nip rolls on top. The tube or “web” of film is then continuously rolled up by take-off rollers.

Conversion Process—

The film rolls obtained from the blown film extrusion process are fed into a bag converter machine, where the tube is heat-sealed across its width to form the bottom of the bags, where a special die cut punches and perforates the film to produce the micro-perforation holes and then the film is cut across further up to form the opening (mouth of the bag). Finished bags are collected at the end of the machine process and packed in individual packages. The bags are about 3.1 feet in length and about 3.25 feet in width and contain 68 micro-perforation holes (0.5 mm in diameter). The bag can hold 30 lbs of produce (bananas).

Bag Utilization—

Once the fruit is ready to be packed, the bag is opened and placed centered inside the box bottom component. Then, the packer packs the fruit inside the bag in accordance with the packing SOP recommended for each specific packing system. Depending on final product requirements, the bag can be hermetically sealed at the point of packing (in the Tropics), or the bag can be left open during shipping and sealed at market. If the bag is to be sealed in the Tropics, once the fruit is packed, the remaining plastic of the bag is collected at its top in order to hermetically close the bag. It can be sealed using a heat-sealer or folded in such a way to make a knot, which is tied up with adhesive tape or by a rubber band. Once the bag is closed, the box cover component is placed on top and the final box is sent to the stowing area where it is palletized to form the pallet loads. The pallets are loaded into containers and shipped to the market. The fruit in the sealed bags may be exposed to ethylene in the course of shipment (for example, at the distribution center) to begin the ripening process.

What is claimed is:

1. A film for wrapping respiring produce comprising from about 60% to about 90% of an ethylene vinyl acetate (EVA) mixture which consists of ethylene vinyl acetate and vinyl acetate, and the balance of the film comprising a second resin selected from food-safe EVA-compatible thermoplastic resins, the film having a thickness of from about 0.5 to about 5 mils.

2. The film according to claim 1 wherein the second resin is selected from low density polyethylene, linear low density polyethylene, and mixtures thereof.

3. The film according to claim 2 which includes micro-perforations going through the film.

4. The film according to claim 2 which comprises about 80% of the ethylene vinyl acetate mixture, and wherein the second resin comprises linear low density polyethylene.

5. The film according to claim 1 wherein the EVA mixture consists of about 75% to about 90% ethylene vinyl acetate and from about 10% to about 25% vinyl acetate.

6. The film according to claim 1 which is not a laminate.

7. The film according to claim 2 which comprises from about 10% to about 40% of the second resin.

8. A bag for the shipment of respiring produce comprising a rectangular top sheet and a rectangular bottom sheet joined together along at least three of their edges, at least a portion of said top sheet and said bottom sheet made from a film comprising from about 60% to about 90% of an ethylene vinyl acetate (EVA) mixture which consists of ethylene vinyl acetate and vinyl acetate, and the balance of the film comprising a second resin selected from food-safe, EVA-compatible thermoplastic resins.

9. The bag according to claim 8 wherein the second resin is selected from low density polyethylene, linear low density polyethylene, and mixtures thereof.

10. The bag according to claim 9 wherein the complete top and bottom sheets are made from the defined film.

11. The bag according to claim 9 wherein the film is not a laminate.

12. The bag according to claim 10 which is from about 8″ to about 52″ in length, and from about 3″ to about 40″ wide.

13. The bag according to claim 12 wherein the film used to make the bag has a thickness of from about 0.5 to about 5 mils.

14. The bag according to claim 13 wherein the second resin comprises linear low density polyethylene.

15. The bag according to claim 14 which comprises about 80% of the ethylene vinyl acetate mixture.

16. The bag according to claim 8 wherein the EVA mixture consists of from about 75% to about 90% ethylene vinyl acetate and from about 10% to about 25% vinyl acetate.

17. The bag according to claim 8 wherein one or both of the sheets includes micro-perforations through the film material.

18. The bag according to claim 17 which includes from about 1 to about 100 micro-perforations per sheet, each micro-perforation being from about 0.1 to about 12.5 mm in diameter.

19. A method for shipping respiring produce comprising the steps of placing said produce in one or more bags according to claim 8, and shipping said produce from an origination point to a destination point.

20. The method according to claim 19 wherein the produce is bananas.

21. The method according to claim 20 wherein the fourth edge of the bag is sealed after the bananas are placed in the bag and prior to shipping.

22. The method according to claim 21 wherein the bananas are gassed with ethylene prior to the sealing of the bag.

23. The method according to claim 20 wherein the fourth edge of the bag is sealed after the bananas reach their destination point.

24. The method according to claim 20 wherein the bag is formulated such that the atmosphere within the sealed bag of bananas during at least a portion of shipping, includes from about 2% to about 12% oxygen and from about 3% to about 13% carbon dioxide.

25. The process according to claim 20 wherein the film used to make the bag has a thickness of from about 0.5 to about 5 mils.

26. The process according to claim 25 wherein the second resin in the film used to make the bag comprises linear low density polyethylene.

27. The process according to claim 26 wherein the film used to make the bag includes micro-perforations through the film.

28. The process according to claim 27 wherein the bag includes from about 1 to about 100 micro-perforations per sheet, each micro-perforation having a diameter of from about 0.1 to about 12.5 mm.
